(19) United States
(12) Patent Application Publication
(10) Pub. No.: US 2014/0291142 A1
(43) Pub. Date: Oct. 2, 2014

(54) PHOTOELECTRODE FOR PHOTOELECTROCHEMICAL CELL, METHOD OF MANUFACTURING THE SAME, AND PHOTOELECTROCHEMICAL CELL INCLUDING THE SAME

(71) Applicant: Intellectual Discovery Co., Ltd., Seoul (KR)

(72) Inventors: Hyeong tag Jeon, Seoul (KR); Giyul Ham, Seoul (KR); Hagyoung Choi, Seoul (KR); Seokyoon Shin, Goyang-si (KR)

(73) Assignee: Intellectual Discovery Co., Ltd., Seoul (KR)

(21) Appl. No.: 14/158,175

(22) Filed: Jan. 17, 2014

(30) Foreign Application Priority Data
Mar. 28, 2013 (KR) 10-2013-0033836

(51) Int. Cl. H01G 9/20; C25B 1/00

(52) U.S. Cl. CPC H01G 9/2031; C25B 1/003
USPC 204/242; 204/290.13; 438/89

(57) ABSTRACT

A photoelectrode for a photoelectrochemical cell, a method of manufacturing the same, and a photoelectrochemical cell including the same, the photoelectrode including TiO₂ nanotubes, and a TiO₂ layer coated on the TiO₂ nanotubes.

### CROSS-REFERENCE TO RELATED APPLICATION

This application claims priority to and the benefit of Korean Patent Application No. 10-2013-0033836 filed in the Korean Intellectual Property Office on Mar. 28, 2013, the entire contents of which are incorporated herein by reference.

### BACKGROUND OF THE INVENTION

1. Field of the Invention

A photoelectrode for a photoelectrochemical cell, a method of manufacturing the same, and a photoelectrochemical cell including the same are provided.

2. Description of the Related Art

Hydrogen has been widely used as a base material for chemical products and a process gas in chemical plants, and is recently been in more demand as a raw material for fuel cells in future energy technology. Hydrogen is also evaluated as the most potent and only alternative for solving environmental problems and the price rise or depletion of fossil fuels which humans currently face. Particularly, research on the preparation, storage, and use of hydrogen is being actively conducted all over the world in the 21^{st} century, in order to prepare against global warming and air pollution and prepare for energy security and supply.

Photolysis of water, which is one of technologies of producing hydrogen, may be the most ideal technology for future humans since solar energy, which is an absolute energy source, and water, which is an indefinite resource, are directly used. Particularly, water splitting through a photocatalytic action of titanium dioxide (TiO₂) nanoparticles has potential for environmentally friendly solar-hydrogen production for a future hydrogen economy.

However, this technology has disadvantages in that the solar-hydrogen energy conversion efficiency is uneconomically low, the photo-generated electron/hole pairs are quickly recombined and the inverse reaction easily occurs, and the activation of TiO₂ by visible light is low.

In order to solve the above problems, TiO₂ nanotubes have recently been used for water splitting. Since nanotubes increase the light scattering to improve the light absorption and make electrons be in a free state for a longer time, the efficiency of TiO₂ nanotubes is five times higher than the existing thin film type of TiO₂.

Meanwhile, the water splitting technology may be largely classified into a method of using a particle type of photocatalyst and a photoelectrochemical method using a photoelectrode type. As for the photoelectrochemical method, when a photoelectrode is radiated with light, photons having energy higher than the band gap energy are absorbed to generate electron-hole pairs. Here, the holes directly oxidize water on a surface of an n-type semiconductor to generate oxygen, and the electrons flow through an external circuit to generate hydrogen at the counter electrode. Therefore, according to the photoelectrochemical method, hydrogen and oxygen can be separated and generated, and an artificial bias voltage may be applied to the photoelectrode for improvement in efficiency.

The above information disclosed in this Background section is only for enhancement of understanding of the background of the invention and therefore it may contain information that does not form the prior art that is already known in this country to a person of ordinary skill in the art.

### SUMMARY OF THE INVENTION

An embodiment provides a photoelectrode for a photoelectrochemical cell, the photoelectrode including TiO₂ nanotube, and a TiO₂ layer coated on surfaces of the TiO₂ nanotube.

The thickness of the TiO₂ layer may be 15 nm or smaller.

The photoelectrode may further include nanoparticles of a metal or a metal oxide on the TiO₂ layer.

The average diameter of the nanoparticles may be 0.1 to 5 nm.

The metal or a metal of the metal oxide may be Ti, Ru, Ag, Ag, Al, Cu, Pt, Au, Mn, Ni, Zn, Zr, Mo, Os, Pd, Ir, Ta, or a combination thereof.

The average outer diameter of the TiO₂ nanotubes may be 10 to 1000 nm.

The average wall thickness of the TiO₂ nanotubes may be 0.1 to 100 nm.

An embodiment provides a method of manufacturing a photoelectrode for a photoelectrochemical cell, the method including: preparing amorphous TiO₂ nanotubes by anodizing a Ti substrate; crystallizing the amorphous TiO₂ nanotubes through heat treatment; bonding the crystallized TiO₂ nanotubes on a substrate; and forming a TiO₂ layer on surfaces of the crystallized TiO₂ nanotubes, through atomic layer deposition (ALD).

The anodizing may be performed by potentiostatic anodization using a cell having two electrodes.

The crystallizing of the amorphous TiO₂ nanotubes through heat treatment may be performed at a temperature of from 200 to 800° C.

The atomic layer deposition (ALD) may be performed once or more but less than 70 times.

The atomic layer deposition (ALD) may be remote plasma atomic layer deposition (RPALD).

The anodizing may be performed by using an electrolyte containing NH₄F and ethylene glycol.

The anodizing may be performed twice or more.

The anodizing may be performed at room temperature.

The atomic layer deposition (ALD) may be remote plasma atomic layer deposition (RPALD) using titanium tetraisopropoxide [Ti(OC(CH₃)₂)₄] as a Ti precursor and O₂ plasma as a reactant.

The atomic layer deposition (ALD) may be performed at a temperature of from 70 to 150° C.

An embodiment provides a photoelectrochemical cell for photolysis of water, the photoelectrochemical cell including a photoelectrode having TiO₂ nanotubes and a TiO₂ layer is coated on surfaces of the TiO₂ nanotube, and an auxiliary electrode, wherein the photoelectrode and the auxiliary electrode are electrically connected to each other.

### BRIEF DESCRIPTION OF THE DRAWINGS

FIG. 1 shows an SEM image of TiO₂-coated nanotubes prepared in an example; and

FIG. 2 shows an SEM image of an enlargement of FIG. 1.

### DETAILED DESCRIPTION OF THE EXEMPLARY EMBODIMENTS

Hereinafter, embodiments will be described in detail. However, these embodiments are merely exemplified, and the scope of protection is not limited thereto but defined by the appended claims.

In an embodiment, a photoelectrode for a photoelectrochemical cell is provided, the photoelectrode including TiO₂ nanotubes, and a TiO₂ layer coated on surfaces of the TiO₂ nanotubes.

Due to the TiO₂ layer, the TiO₂ nanotubes can obtain further improved hydrogen conversion efficiency as compared with existing TiO₂ nanotubes.

The thickness of the TiO₂ layer may be 15 nm or smaller. However, the thickness thereof is not limited thereto. In addition, the average outer diameter of the TiO₂ nanotubes may be 10 to 1000 nm, but is not limited thereto. Further, the average wall thickness of the TiO₂ nanotubes may be 0.1 to 100 nm, but is not limited thereto.

In addition, the photoelectrode may further include nanoparticles of a metal or a metal oxide formed on the TiO₂ layer. When the nanoparticles of a metal or a metal oxide are further included, the hydrogen conversion efficiency can be further improved due to a surface plasmon phenomenon with the TiO₂ layer.

The average diameter of the nanoparticles may be 0.1 to 5 nm, but is not limited thereto.

The metal or a metal of the metal oxide may be Ti, Ru, Ag, Ag, Al, Cu, Pt, Au, Mn, Ni, Zn, Zr, Mo, Os, Pd, Ir, Ta, or a combination thereof.

In an embodiment, a method of manufacturing a photoelectrode for a photoelectrochemical cell is provided, the method including: preparing amorphous TiO₂ nanotubes by anodizing a Ti substrate; crystallizing the amorphous TiO₂ nanotubes through heat treatment; bonding the crystallized TiO₂ nanotubes on a substrate; and forming a TiO₂ layer on surfaces of the crystallized TiO₂ nanotubes, through atomic layer deposition (ALD).

The surface of a three-dimensional structure can be more uniformly coated by atomic layer decomposition (ALD).

Atomic layer decomposition (ALD) has been actively studied since the development of nano-level semiconductors with a line width of 100 nm or smaller has been regularized. Atomic layer decomposition (ALD) is an advanced technology in which thin films are formed by the atomic layer unit.

The anodizing may be performed by potentiostatic anodization using a cell having two electrodes.

In addition, the crystallizing of the amorphous TiO₂ nanotubes through heat treatment may be performed at a temperature of 200 to 800° C. The temperature may be 300 to 700° C., or 400 to 500° C.

In addition, the atomic layer decomposition (ALD) may be performed once or more but less than 70 times. The size of particles may be controlled depending on the number of times of atomic layer decomposition (ALD), and thus the thickness of the coating layer may be controlled.

The atomic layer decomposition (ALD) may be remote plasma atomic layer decomposition (RPALD). The atomic layer decomposition (ALD) may be remote plasma atomic layer decomposition (RPALD), using titanium tetraisopropoxide [Ti(OC(CH₃)₂)₄] as a Ti precursor and O₂ plasma as a reactant. However, the atomic layer decomposition (ALD) is not limited thereto.

The atomic layer decomposition (ALD) may be performed at a temperature of 70 to 150° C. The atomic layer decomposition (ALD) may be performed at a temperature of 90 to 120° C.

The anodizing may be performed by using an electrolyte containing NH₄F and ethylene glycol. The anodizing may be performed twice or more. Due to this, the formation of nanograss can be suppressed.

The anodizing may be performed at room temperature, but is not limited thereto.

In an embodiment, a photoelectrochemical cell for photolysis of water is provided, the photoelectrochemical cell including a photoelectrode including TiO₂ nanotubes, a TiO₂ layer coated on the TiO₂ nanotubes, and an auxiliary electrode, wherein the photoelectrode and the auxiliary electrode are electrically connected to each other.

In an embodiment, a photoelectrode for a photoelectrochemical cell and a method of manufacturing the same may have advantages of improving the photoelectrode and thus, increasing the hydrogen yield when the improved photoelectrode is applied as a photoelectrode for water splitting, by forming the photoelectrode to contain TiO₂ nanotubes.

According to an embodiment, a photoelectrode having improved hydrogen conversion efficiency can be provided. Further, a method of effectively manufacturing the photoelectrode can be provided.

Hereinafter, examples and comparative examples will be described. However, the following examples are merely for illustrating the present invention, but the present invention is not limited thereto.

### EXAMPLES

### Example: Anodizing

A highly arranged TiO₂ nanotube array was prepared by potentiostatic anodization using an electrochemical cell having two electrodes. Ti foil (0.127 mm, purity 99.7%, Aldrich) was used as an electrode and Pt gauze was used as counter electrode. Prior to anodization, the Ti foil was washed by ultrasonic treatment in an acetone, isopropanol, or ethanol solvent. Then, washing with deionized (DI) water and drying with nitrogen steam were performed. The two electrodes were disposed at an interval of 1.5 cm, and 0.5 wt % of NH₄F (Aldrich, purity: 99.8%) and ethylene glycol (Aldrich, purity: 99.9%) were used as an electrolyte.

A double anodizing method was employed to prevent the formation of nanograss. First, the Ti foil was anodized at 50 V for 2 hours, and then subjected to ultrasonic treatment in a 30% solution of H₂O₂ (Aldrich) for 15 min, followed by washing with DI water and drying. Then, the Ti foil was anodized at 50V for 3 hours in the electrolyte, and then subjected to ultrasonic treatment in isopropanol for 15 min, followed by drying in air. The two anodizing processes were conducted at room temperature while stifling was continuously and slowly conducted.

### Example: Transferring Nanotube Film to Transparent Conductive Oxide Substrate

In order to crystallize the amorphous TiO₂ nanotube array formed on the Ti foil, heat treatment was performed thereon at 450° C. for 3 hours, while the temperature was increased at a rate of 2° C./min. The heat-treated Ti foil and amorphous TiO₂ nanotube array were again anodized at 50 V for 30 min, and then immersed in a 30% solution of H₂O₂ (Aldrich). The amorphous TiO₂ layer formed through the anodizing process after heat treatment was dissolved in H₂O₂, and thus, a crystalline white TiO₂ nanotube array (TNTA) film was separated. The TNTA film was transferred to a Petri dish containing isopropyl alcohol. This crystalline TNTA was transferred to a transparent conductive oxide substrate (TCO substrate). In order to strongly fix the TNTA film to a fluorine-doped tin oxide (FTO) film, some droplets of a solution in which titanium butoxide was added to isopropanol were dripped thereon. Last, the TNTA film on the FTO film was heated at 200° C. for 30 min on a heating substrate, and then heated at 450° C. in air for 30 min.

Example: Atomic Layer Deposition of TiO₂

A thin amorphous TiO₂ layer of ˜15 nm was coated on the TNTA film on the FTO film by using atomic layer deposition (ALD). Here, the deposition was performed at 100° C. by remote plasma atomic layer deposition (RPALD) using titanium tetraisopropoxide [Ti(OC(CH₃)₂)₄] as a Ti precursor and O₂ plasma as a reactant. The two deposited films were immersed in water (watery NH₄F solution) for 24 hours and 48 hours, respectively.

### Experimental Example

### Evaluation

The crystal surface of the TNTA film was analyzed by X-ray diffraction through an analyzer (Rigaku D/Max 2000) using the Cu K_{α}, light source (1.54 Å). The surface structure, pore size, wall thickness, TNTA length, and the like were evaluated through field-emission scanning electron microscopy (FE-SEM, JEOL-JSM 6330F). The depth profile was evaluated through transmission electron microscopy (TEM, JEOL 2010).

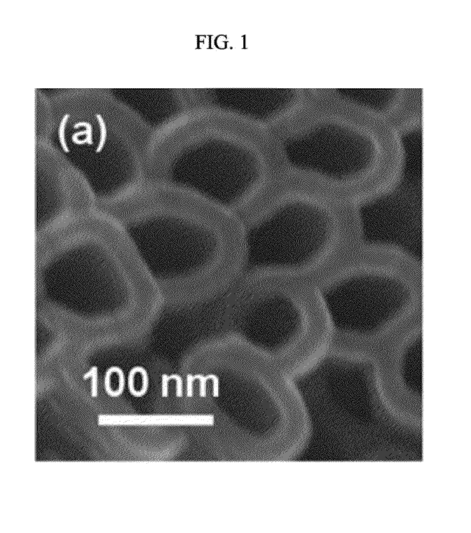

FIG. 1 shows an SEM image of TiO₂-coated nanotubes prepared in the example. Nanotubes that were uniformly and smoothly formed are shown in FIG. 1.

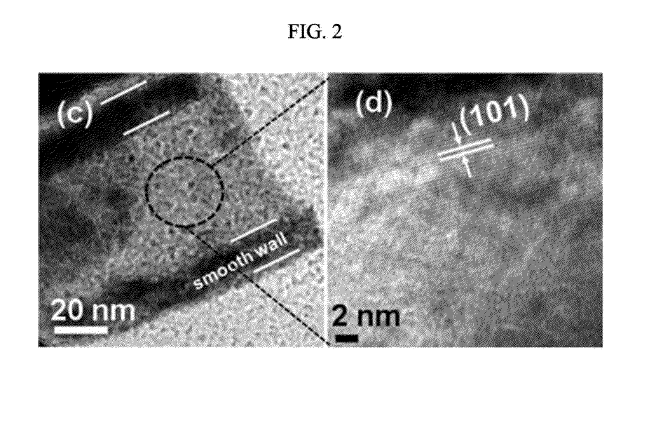

FIG. 2 shows an SEM image of an enlargement of FIG. 1.

It can be seen from FIGS. 1 and 2 that the thickness of the TiO₂ layer was 15 nm or smaller. In addition, it can be seen that the coating layer was an amorphous TiO₂ layer.

Further, it can be confirmed that the average outer diameter of the crystalline nanotubes was approximately 90 to 110 nm, and the average wall thickness thereof was approximately 5 to 7 nm. In addition, it can be seen that the average length of the nanotubes was 7 μm or smaller.

As a result of XRD measurement of nanotubes prepared in the example, the TNTA film was TiO₂ (anatase), but rutile and brookite type peaks were not observed.

As described in the example, the TiO₂ nanotubes coated with the TiO₂ layer can increase the hydrogen yield in the hydrogen conversion water splitting reaction. Further, when metal or metal oxide particles are further included in the TiO₂ coating layer, the hydrogen conversion efficiency can be further improved, due to a surface plasmon phenomenon.

The present invention is not limited to the above exemplary embodiments and may be implemented into different forms, and those skilled in the art will understand that the present invention may be implemented in alternative embodiments without changing technical spirits and necessary characteristics of the present invention. Thus, the embodiments described above should be construed as being exemplified and not limiting the present disclosure.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A photoelectrode for a photoelectrochemical cell, the photoelectrode comprising:
TiO₂ nanotubes, and
a TiO₂ layer coated on the TiO₂ nanotubes.

2. The photoelectrode of claim 1, wherein the TiO₂ layer is about 15 nm thick or less.

3. The photoelectrode of claim 1, further comprising metal or metal oxide nanoparticles disposed on the TiO₂ layer.

4. The photoelectrode of claim 3, wherein the average diameter of the nanoparticles is from 0.1 to 5 nm.

5. The photoelectrode of claim 3, wherein the nanoparticles comprise at least one metal selected from the group consisting of Ti, Ru, Ag, Ag, Al, Cu, Pt, Au, Mn, Ni, Zn, Zr, Mo, Os, Pd, Ir, and Ta.

6. The photoelectrode of claim 1, wherein the average outer diameter of the TiO₂ nanotubes is from 10 to 1000 nm

7. The photoelectrode of claim 1, wherein the average wall thickness of the TiO₂ nanotubes is from 0.1 to 100 nm

8. A method of manufacturing a photoelectrode for a photoelectrochemical cell, the method comprising:
preparing amorphous TiO₂ nanotubes by anodizing a Ti substrate;
crystallizing the amorphous TiO₂ nanotubes through a heat treatment;
bonding the crystallized TiO₂ nanotubes to a substrate; and
forming a TiO₂ layer on the crystallized TiO₂ nanotubes, through atomic layer deposition (ALD).

9. The method of claim 8, wherein the anodizing comprises a potentiostatic anodization using a cell comprising two electrodes.

10. The method of claim 8, wherein the crystallizing of the amorphous TiO₂ nanotubes is performed at a temperature of from 200 to 800° C.

11. The method of claim 8, wherein the atomic layer deposition (ALD) is performed for from one time to 70 times.

12. The method of claim 8, wherein the atomic layer deposition (ALD) comprises a remote plasma atomic layer deposition (RPALD).

13. The method of claim 8, wherein the anodizing is performed by using an electrolyte containing NH₄F and ethylene glycol.

14. The method of claim 8, wherein the anodizing is performed at least twice.

15. The method of claim 8, wherein the anodizing is performed at room temperature.

16. The method of claim 8, wherein the atomic layer deposition (ALD) comprises a remote plasma atomic layer deposition (RPALD) using titanium tetraisopropoxide [Ti(OC(CH₃)₂)₄] as a Ti precursor and an O₂ plasma as a reactant.

17. The method of claim 8, wherein the atomic layer deposition (ALD) is performed at a temperature of from 70 to 150° C.

18. A photoelectrochemical cell configured for photolysis of water, the photoelectrochemical cell comprising:
a photoelectrode comprising TiO₂ nanotubes;
a TiO₂ layer coated on the TiO₂ nanotubes, and
an auxiliary electrode,
wherein the photoelectrode and the auxiliary electrode are electrically connected to each other.
